(19) United States
(12) Patent Application Publication
(10) Pub. No.: US 2005/0214520 A1
(43) Pub. Date: Sep. 29, 2005

(54) Granular thin film, perpendicular magnetic recording medium employing granular thin film and magnetic recording apparatus

(75) Inventors: Soichi Oikawa, Kawasaki-shi (JP); Takeshi Iwasaki, Kawasaki-shi (JP); Tomoyuki Maeda, Kawasaki-shi (JP); Akira Kikitsu, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/079,190

(22) Filed: Mar. 15, 2005

(30) Foreign Application Priority Data
Mar. 25, 2004 (JP) P2004-090671

(51) Int. Cl. B32B 5/16; G11B 5/64

(52) U.S. Cl. 428/323; 428/832

(57) ABSTRACT

A perpendicular magnetic recording medium suitable for attaining a low noise high magnetic recording density is obtained. The medium has a small average magnetic grain diameter, a small magnetic grain diameter distribution, a high perpendicular crystallographic magnetic grain orientation and a high regularity magnetic grain arrangement. The perpendicular magnetic recording medium comprises a soft magnetic layer, a granular under-layer and a perpendicular magnetic recording layer on a substrate. The granular under-layer is formed on a metal under-layer. The metal grains in the granular layer are separated by nonmagnetic inter-grain material and are partially penetrated into the metal under-layer. The perpendicular magnetic recording layer is formed on the granular layer. Then a perpendicular magnetic recording medium shows high signal to noise ratio and excellent high-density recording characteristics.

### CROSS-REFERENCE TO RELATED APPLICATIONS

This application is based upon and claims the benefit of priority from the prior Japanese Patent Application No. 2004-90671, filed on Mar. 25, 2004; the entire contents of which are incorporated herein by reference.

### BACKGROUND

1. Field of the Invention

This invention relates generally to a granular thin film, a perpendicular magnetic recording medium having the granular layer and a magnetic recording and reproducing apparatus employing the perpendicular magnetic recording medium.

2. Description of the Related Art

Hard disk drives (HDDs) have become major recording devices in various fields including home video systems, audio sets and car navigation systems, not limited in the usual application fields such as computer memories for their low cost, high data access speed and high reliability in data storage. With expanding the fields of applying HDDs, demands for realizing HDDs having larger recording capacity have been increased. To satisfy these demands, magnetic recording disks having larger recording densities have been developed in a very high pace.

Smaller magnetic grain sizes have been pursued to obtain smaller recording bit size for the magnetic recording media of HDDs having higher recording densities. As the average magnetic grain size of a magnetic layer has been made smaller, we have encountered to a problem of thermal fluctuation durability deterioration due to smaller grain size components of the magnetic grains. Another problem we have encountered is an appearance of medium noise increase and recording imperfections caused by relatively large size magnetic grain components as a result of unsatisfactory grain size distribution control. At present, there remains much room for reducing the medium noise since crystallographic orientation and arrangement order control of the magnetic grains are not sufficient yet.

In patent document 1 (Japanese Patent Laid-open Application No. 2003-36525), the magnetic recording medium having a structure of substrate (Ta, CoZrNb) (NiFe alloy-Cr₂O₃, Ru—SiO₂)/RuW/CoCrPt as a solutions for the problem is disclosed. This medium structure is intended to obtain separated fine crystalline grain structure with decreased magnetic interaction between the crystalline grains using the under-layer since chromium metal segregation effect is not significant for perpendicular magnetic recording media. Although the magnetic grains in this magnetic recording medium is very small, the control of the crystallographic orientation, the arrangement regularity and the grain diameter distribution of the magnetic grains are not sufficient, because the granular structured under-layer is formed simply by a sputtering method.

In patent document 2 (Japanese Patent Application Laid-open No. 2003-77122), the magnetic recording media having structures such as substrate/(Ni—P, CoZr)/(Pt, Pd, NiFe/(Ru, Re)/CoCrPt—SiO₂ are disclosed. In these magnetic recording media, the degree of the crystallographic orientation for the magnetic crystalline particles is improved by the hexagonal close packed (hcp) crystal structure under-layer on the face centered cubic (fcc) seed layer. Although a good crystalline orientations of the grains are obtained in these construction, the crystal size and crystal arrangements are not controlled sufficiently, because the layers are formed simply by controlling sputtering conditions for pure metals or alloys.

The films disclosed in patent document 3 (Japanese Patent Laid-open Application No. 2000-327491) are inorganic thin films carrying grains having crystalline orientation and regular two dimensional honeycomb arrangements having geometrically fractal structures exhibiting similarity to themselves. In this patent reference, layered structures such as substrate/CoO—SiO₂/(CrTi)/CoCrPt were also disclosed. This medium structure having reduced crystalline size distribution is applied for decreasing the thermal fluctuation, reducing the medium noise by obtaining an ordered grain arrangement structure, and also for improving corrosion resistance of the magnetic films. The inorganic films have attained an ordered grain arrangement and a small grain size distribution as a result of the combination with the oxide films. The orientation of the magnetic grains in the layer, however, is along the in-plane (102) direction and not for perpendicular orientation since the crystallographic orientation of the CoO grains is along the (220) direction. Moreover, the crystallographic orientation and the orientation degree distribution cannot be controlled because any effective procedure for controlling the crystallographic orientation and the orientation degree distribution, for example, formation of a CoO—SiO₂ under-layer or crystalline grains partially entering into the under-layer is not disclosed.

Furthermore, in patent document 4 (Japanese Patent Laid-open Application No. 2002-163819), layered structure of substrate/CoTaZr/(Hf)/CoO—SiO₂/(Hf)/TbFeCo is disclosed. In this structure, pinning sites of regularly shaped uneven portions or crystallographically coupled portions for suppressing domain wall motions in the recording layer are formed. The soft magnetic layers are helpful for applying magnetic head field effectively to the recording layers. The layered structures of this disclosure are designed to obtain perpendicular double layer media comprising a soft magnetic layer, a magnetic recording layer and a layer having a ordered inorganic grain arrangement with a good grain size dispersion. The disclosed layered structures, however, are not suited for the purposes of attaining perpendicular grain orientation, grain size distribution suppression and ordered grain arrangement, because the Hf, Ru, Ti, Ta, Nb, Cr, Mo, W, C, Si₃O₄, Al₂O₃, Cr₂O₃, SiO₂ and NiP are desirable as the under-layer of the disclosure. These under-layer materials are for continuous recording layer in which crystallographic orientation is not necessary.

### SUMMARY

For the foregoing reason, there have been requirements of obtaining a new technology exceeding the prior art for attaining small magnetic grains in the magnetic layer with small grain size dispersion, high crystallographic grain orientation especially to the perpendicular direction and high grain arrangement regularity, in order to realize a perpendicular magnetic recording medium suitable for high density magnetic recording having small medium noise and sufficient durability to thermal fluctuation.

The present invention is intended to reply to the requirement. The granular film of the present invention comprises a substrate, a metal under-layer on the substrate and a granular layer on the metal under-layer. The granular layer comprises metal grains partially penetrating the volume into the metal under-layer and inter-grain material separating the metal grains.

Furthermore, the inter-grain material comprises at least one selected from the group consisting of oxide, nitride and carbide. A perpendicular magnetic recording medium of the present invention comprises a substrate, a soft magnetic-layer on the substrate, a metal under-layer on the soft magnetic layer, a granular layer on the soft magnetic layer, and a perpendicular magnetic recording layer on the granular film layer. The granular layer comprises metal grains partially penetrating the volume into the metal under-layer and inter-grain material separating the metal grains. Furthermore, the inter-grain material comprises at least one selected from the group consisting of oxide, nitride and carbide.

The magnetic recording and reproducing apparatus of the present invention comprises the perpendicular magnetic recording medium stated above, a driving mechanism driving the perpendicular magnetic recording medium, a recording and reproducing head recording information to the perpendicular magnetic recording medium and reproducing the information from the perpendicular magnetic recording medium, a head driving mechanism driving the recording and reproducing head, and a recording and reproducing signal processing system processing recording and reproducing signal.

The perpendicular recording medium of the present invention is fabricated as follows. First of all, a granular structured under-layer is formed using material that can form regular arrangement of small size grains although the crystalline orientation degree of the grains is not so high. Then these grains having enough orientation is removed from the layer and make holes until the bottom of the holes attain at the end of the layer. Finally the holes are filled with metals with good crystalline orientation in accordance with the crystallinity of the under-layer. In this way, a granular layer having regular arrangement, good crystalline orientation and small grain size can be obtained at the same time.

Forming this granular layer on a soft magnetic under layer and forming a magnetic layer on the granular layer, a perpendicular magnetic recording medium comprising magnetic grains having regular arrangement, good crystalline orientation and small grain size can be obtained at a same time. Furthermore, the magnetic spacing between the recording head and the soft magnetic layer is decreased.

According to the present invention, coexistence of regular grain arrangement, good crystalline orientation and fine grain size with small grain size dispersion can be attained in a perpendicular magnetic recording medium. Furthermore, the magnetic spacing between the recording and reproducing head and the perpendicular magnetic medium can be reduced.

### BRIEF DESCRIPTION OF THE DRAWINGS

FIG. 1 shows a schematic cross sectional view of an embodiment of a granular film according to the present invention.

FIG. 2 shows a schematic cross sectional view of an embodiment of a perpendicular magnetic recording medium according to the present invention.

FIG. 3 shows a in-plane schematic cross sectional view of the perpendicular magnetic layer for an embodiment of a perpendicular magnetic recording medium according to the present invention.

FIG. 4 shows an oblique view of an embodiment of a perpendicular magnetic recording and reproducing apparatus according to the present invention.

### DETAILED DESCRIPTION

The preferred embodiments of the present invention will be described with reference to figures.

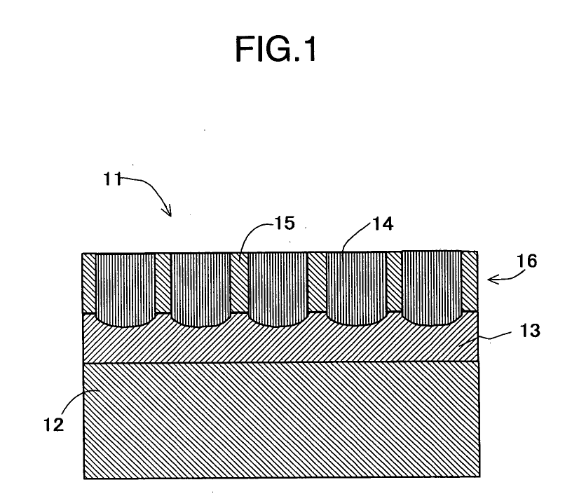

FIG. 1 is a schematically shown cross sectional view of an embodiment for the granular film of the present invention. In FIG. 1, the granular film 11 is composed of a substrate 12, a metal under-layer 13 on the substrate 12, and a granular layer 16 comprising metal grains 14 and inter-grain material 15 composed of material such as an oxide.

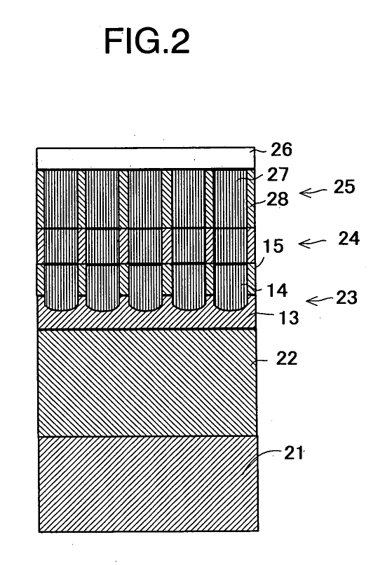

FIG. 2 is a schematically shown cross sectional view of an embodiment according to the perpendicular magnetic recording medium of the present invention employing the granular film shown in FIG. 1. In FIG. 2, a soft magnetic layer 22 is formed on the substrate 21, and a granular film 23 is formed on the soft magnetic layer 22. Similar to the granular film of FIG. 1, the granular film 23 is composed of the metal under-layer 13, the metal grains 14 and the inter-grain material 15 of such as oxide or other similar material. A perpendicular magnetic recording layer 25 is formed above the granular film layer 23 through a intermediate layer 24, and a protective layer 26 is formed on the perpendicular magnetic recording layer 25. The perpendicular magnetic recording layer 25 can form a granular structure in which magnetic grains 27 are separated each other by inter-grain material 28.

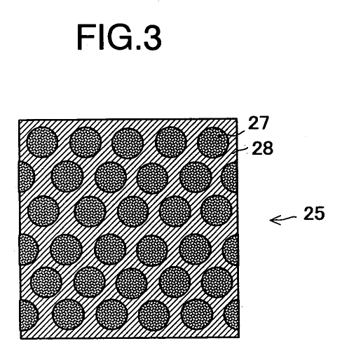

A regular arrangement can be given to the magnetic grains 27 of the perpendicular magnetic recording layer 25. As schematically shown in FIG. 3, the magnetic grains 27 separated by the inter-grain material 28 can be arranged, for example to a structure having hexagonal symmetry in the plane.

Thus, it is desirable that the perpendicular magnetic recording layer 25 of the perpendicular magnetic recording medium of the present invention has a granular film structure comprising magnetic grains 27 and nonmagnetic inter-grain material 28, and the magnetic grains 27 are arranged regularly in the layer plane.

It has been known that the magnetic grains 27 with smaller grain diameter of a prior art medium have a problem of lower durability to thermal fluctuation, although the smaller grain diameter is desirable for obtaining higher recording density. According to the present invention, good durability for thermal fluctuation can be obtained even if the average diameter of the magnetic grains 27 is 20 nm or less. The magnetic grains 27 having average grain diameter of 6 nm or less are more desirable for the perpendicular magnetic recording layer of the present invention.

The desirable metal grains 14 of the granular film layer 23 are the grains having hexagonal close packed or face centered cubic crystal structure, and the desired nonmagnetic inter-grain material 15 is oxide material with amorphous structure. The grains of at least one metal selected from the group consisting of Ru, Rh, Re, Pd, Pt, and Ni are suitable as the metal grains 14 of the granular film layer.

Oxide material having at least one selected from the group consisting of silicon oxide, titanium oxide, aluminum oxide, zinc oxide and tantalum oxide as the primary component is suitable for the inter-grain material 15 of the granular film layer.

A metal under-layer having at least one selected from the group consisting of Pd, Pt, Fe, Co and Ni as the primary component is suitable for the metal under-layer 13.

In the perpendicular magnetic recording medium of the present invention, an intermediate layer 24 can be placed between the granular layer 23 and the perpendicular magnetic recording layer 25. Materials having at least one selected from the group consisting of Ru, Rh and Re as the primary component can be used as the material for the intermediate layer 24.

When the metal under-layer 13 is nonmagnetic, the desirable total thickness of granular layer 23 accompanied with the metal under-layer 13 and the intermediate layer 24 is 20 nm or less. When the metal under-layer 13 is magnetic, the desirable total thickness of the granular layer 23 and the intermediate layer 24 is 20 nm or less.

### Embodiment 1

### Substrate

The substrates available for the present invention include substrates of glass, Al alloy, ceramic, carbon, silicon single crystal with oxide surface, and silicon single crystal with Ni—P plating.

The glass substrates include amorphous glass and crystalline glass. The amorphous glasses include soda lime glass or alumino-silicate glass. The crystalline glasses include lithium crystalline glass. The ceramic substrates include sintered ceramic substrates such as commonly used aluminum oxide, aluminum nitride and silicon nitride, and the fiber reinforced ceramic substrates of these ceramics.

Substrates having Ni—P layer formed by sputtering or plating in their surface are desirably used.

### Embodiment 2

### Soft Magnetic Layer

A perpendicular double layer medium is formed disposing a high permeability soft magnetic layer 22 as a back layer of the perpendicular magnetic recording layer. In the perpendicular double layer recording medium, the high permeability soft magnetic layer performs a role of increasing recording and reproducing efficiency of the recording head forming a horizontal return route of the magnetic flux caused for example by a single pole magnetic recording head.

Material containing Fe, Ni or Co can be used as the soft magnetic layer 22. The soft magnetic layer includes, for example, FeCo alloys including FeCo and FeCoV, FeNi alloys including FeNi, FeNiMo, FeNiCr and FeNiSi, FeAl and FeSi alloys including FeAl, FeAlSi, FeAlSiCr, FeAlSiTiRu and FeAlO, FeTa alloys including FeTa, FeTaC and FeTaN, and FeZr alloys including FeZrN.

FeAlO, FeMnO, FeTaN, and FeZrN films having fine crystalline grain structure or a granular structure having dispersed fine crystalline grains in their matrix phase containing 60 atomic % or more of Fe are suitable for the soft magnetic layer 22.

Other materials suitable for the soft magnetic layer 22 are Co alloys containing Co and at least one element selected from Zr, Hf, Nb, Ta, Ti, and Y. The desirable Co content of the layer is 80 at % (atomic percent) or more. These alloy composition easily forms amorphous structured layer by sputtering. Amorphous soft magnetic materials show excellent soft magnetic properties because the amorphous structure is free from the limitation of crystalline anisotropy, crystalline defect and crystalline grain boundary. Low medium noise characteristics can be obtained by using the amorphous magnetic layer as the backing soft magnetic layer.

CoZr, CoZrNb and CoZrTa alloys can be cited as the suitable amorphous soft magnetic materials for the soft magnetic layer 22.

It is desirable to dispose a hard magnetic layer having in-plane magnetization between the nonmagnetic substrate 21 and the soft magnetic layer 22 of the perpendicular magnetic recording medium. Co containing hard magnetic material is suitable for the material of the layer.

The soft magnetic layer forms magnetic domain structure and spike noise appears from domain wall motion of the domain structure. Appearance of the domain walls can be suppressed by applying biasing magnetic field to the soft magnetic layer using the hard magnetic layer magnetized by applying a magnetic field to a radial direction in the layer plane.

CoCrPt alloy and CoSm alloy films, for example, are suitable as the in-plane hard magnetic layer. The desirable coercive force value of the in-plane hard magnetic layer is 39.5 kA/m (0.5 kOe) or more, and the more desirable coercive force value is 79 kA/m (1 kOe) or more. The desirable thickness value of the in-plane hard magnetic layer is 5 to 150 nm, and the more desirable thickness value is 10 to 70 nm. For the purpose of controlling crystallographic orientation of the in-plane hard magnetic layer, Cr alloy or B2 structured material can be formed between the nonmagnetic substrate and the in-plane hard magnetic layer.

An oxide layer can be formed between the soft magnetic layer 22 and the metal under-layer 13. Since the oxide layer does not have crystallographic orientation, a difficult condition for obtaining crystallographic orientation is given to the crystalline grains growing on the layer at the initial stage of the growth.

The oxide layer can be formed by introducing oxygen gas to the soft magnetic layer 22 after deposition or by introducing oxygen gas to the layer at the final stage of forming the soft magnetic layer. Actually the oxide layer can be formed by exposing the surface of the soft magnetic layer to oxygen gas or oxygen gas diluted by inert gas such as argon or nitrogen for 0.3 to 20 seconds. The oxide layer can be formed also by exposing the soft magnetic layer surface to an ambient atmosphere.

### Embodiment 3

### Perpendicular Magnetic Recording Layer

Material composition containing Co as the main component, Pt as an essential component and oxide material as an additional component is suitable for the perpendicular magnetic recording layer 25. Silicon oxide or titanium oxide is suitable for the oxide material.

In the perpendicular magnetic recording layer 25, it is desirable that the magnetic grains 27, namely crystalline grains having magnetization exist in a dispersed state. Moreover, it is desirable that the magnetic grains 27 in the layer form a columnar structure running through the perpendicular magnetic recording layer 25 from the bottom end to the top end of the layer. Formation of the columnar structure implies good grain orientation degree and good grain crystallinity, and leads to an excellent signal to noise ratio of the medium suitable for attaining high recording density.

To obtain the columnar structure, control of oxide content contained in the layer is principally important. The desirable oxide content is in a range from 3 to 12 mol %, and the more desirable content is in a range from 5 to 10 mol % of the total amount of Co, Cr and Pt. These oxide content ranges are desirable because oxides precipitate around the magnetic grains 27 and very small and isolated magnetic grains 27 are formed at the process of producing the layer.

The oxide content exceeding these ranges is undesirable because the oxides remain in the magnetic grains 27 and prevent the grains from attaining good crystalline orientation and grain crystallinity. Moreover, the excessive oxides precipitated at the top sides and the bottom sides of the magnetic grains 27 prevent from forming the columnar structure running through the layer. The oxide content below the ranges stated above are undesirable because the effect of separating between adjacent magnetic grains is insufficient and the effect of grain size control to small sizes is also insufficient, resulting in large medium noise and low signal to noise ratio (S/N ratio).

The desirable Cr content of the perpendicular magnetic layer is from 0 to 16 at %, and the more desirable content is from 10 to 14 at %. The Cr content ranges are desirable because the magnetic grains 27 have appropriate uniaxial anisotropy constant Kᵤ values and high magnetization values to obtain recording and reproducing characteristics and thermal fluctuation stability sufficient for attaining high recording density. The Cr content exceeding the ranges described above is undesirable because the Kᵤ value of the grains is insufficient for obtaining thermal fluctuation stability and for obtaining grain crystallinity and orientation degree, resulting in lower recording and reproducing characteristics.

It is desirable that the Pt content of the perpendicular magnetic recording layer is in a range from 10 to 25 at %. The Pt content in the range is suitable for obtaining Kᵤ values required for perpendicular magnetic recording layer and for obtaining good grain crystallinity and orientation degree, and which results in desirable thermal fluctuation stability and recording and reproducing characteristics suitable for attaining high recording density.

The Pt content exceeding the range is undesirable because an fcc phase appears in the grains 27 and the crystallinity and the orientation of the grains decline. The Pt content less than the range is undesirable because the Kᵤ values of the grains are insufficient for obtaining thermal fluctuation stability required for realizing high-density recording.

The perpendicular magnetic recording layer 25 can contain at least one element selected from the group consisting of B, Ta, Mo, Cu, Nd, W, Nb, Sm, Tb, Ru, and Re, other than the Co, Cr, Pt and oxides described above. Very small grain size, excellent crystallinity and good grain orientation degree can be obtained by containing these elements, and which results in desirable recording and reproducing characteristics and thermal fluctuation stability suitable for realizing high density recording.

It is desirable that the total content of these elements is 8 atomic % or less. The content exceeding 8 atomic % is undesirable because crystalline phases other than the hcp phase appear and the phases disturb crystallinity and crystallographic orientation of the magnetic grains, and which results in insufficient recording and reproducing characteristics and insufficient thermal fluctuation stability for realizing high density recording.

CoPt alloys, CoCr alloys, CoPtCr alloys, CoPtO, CoPtCrO, CoPtSi and CoPtCrSi can be used as the perpendicular magnetic recording layer 25. Multi-layered structure of Co and alloy containing at least one selected from Pt, Pd, Rh and Ru as main component can also be used as the perpendicular magnetic recording layer. Furthermore, Cr, B, or 0 added to these multi-layers of CoCr/PtCr, COB/PdB, CoO/RhO and so on can be used as the perpendicular magnetic recording layer.

The desirable thickness of the perpendicular magnetic recording layer 25 is 5 to 60 nm, and the more desirable thickness of the layer is 10 to 40 nm. When the thickness is in these ranges, the perpendicular recording medium can work as a medium for high-density magnetic recording. When the thickness is less than 5 nm, the reproducing outputs from the medium is too low compared with the noise, and tend to obtain noise component as the dominant outputs. When the thickness exceeds 40 nm, the reproducing outputs from the medium is too high and tend to bring a waveform distortion.

It is desirable that the coercive force of the perpendicular magnetic recording layer 25 is 237 kA/m (3 kOe) or more. When the coercive force is less than 237 kA/m (3 kOe), the thermal fluctuation durability tends to decrease. The desirable squareness ratio in the perpendicular direction of the perpendicular magnetic recording layer is 0.8 or more. When the squareness ratio is less than 0.8, the thermal fluctuation durability of the layer tends to decrease.

### Embodiment 4

### Protective Layer

Typically a protective layer 26 is formed over the perpendicular magnetic recording layer 25. The protective layer 26 is formed to avoid corrosion of the perpendicular magnetic recording layer 25 and to protect the medium surface from damages even if the magnetic head gets contact with the medium surface. Protecting material containing C, SiO₂ or ZrO₂, for example, can be used as the protective layer.

It is desirable that the thickness of the protective layer 26 is in a range between 1 to 10 nm. The thickness can keep the distance between the head and the medium short enough for realizing high-density recording.

A lubricant layer can be placed on the protective layer 26. Perfluoropolyether, alcohol fluorides or carbonic acid fluorides, for example, known as prior art can be used as the lubricant for the lubricant layer.

### Embodiment 5

### Magnetic Recording and Reproducing Apparatus

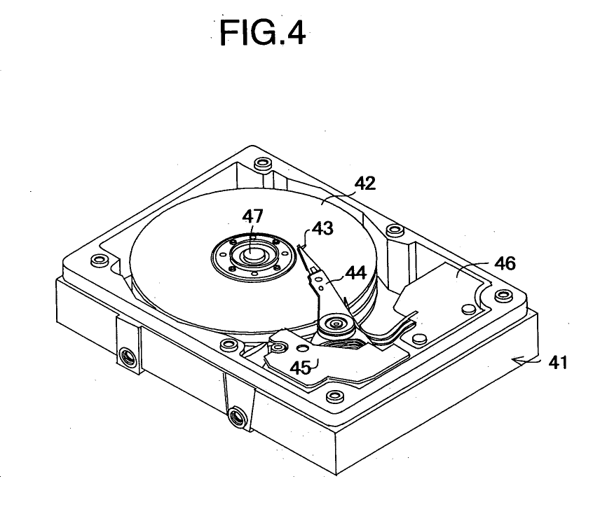

FIG. 4 schematically shows an oblique view of an embodiment for magnetic recording and reproducing apparatus (later abbreviated as magnetic disk drive) according to the present invention. The magnetic disk drive has a magnetic disk 42, a magnetic head 43, a head suspension assembly (suspension and arm) 44, an actuator 45, and circuit board 46 in a case 41.

The magnetic disk 42 installed to a spindle motor 47 is rotated and various digital data are recorded by a perpendicular magnetic recording method. The magnetic head 43 is a hybrid head in which write head having single pole structure and read head having GMR or TMR film sensor are loaded on a common slider mechanism. The read head typically uses a shield type MR head.

The head suspension assembly 44 supports the magnetic head 43 suspending and facing to the surface of magnetic disk 42. The actuator 45 driven by a voice coil motor (VCM) carries magnetic head 43 to an arbitrary radial position of magnetic disk 42 through the suspension assembly 44. A head IC in circuit board 46 generates and outputs drive signals for driving the actuator 45 and control signals for control reading and writing function of the magnetic head.

### EXAMPLE 1

1) Fabrication of Granular Film

Cleaned up disk shaped glass substrates (manufactured by OHARA Co., outer diameter 2.5 inches) were used for the nonmagnetic glass substrates in this example. A glass substrate was put into a DC magnetron sputtering apparatus (ANERVA Co.) chamber and the vacuum chamber was evacuated to 1×10⁻⁵ Pa or less, and then magnetron sputtering was carried out in 0.6 Pa Ar gas atmosphere according to the procedure as described below.

First of all, a Pd under-layer having thickness of 5 nm was formed. Then a 10 nm thick CoO—SiO₂ layer was formed by RF sputtering using a sintered composite target of 20 mol. % SiO₂ added CoO, and then the substrate was took out to the ambient atmosphere.

From in-plane TEM observation of the CoO—SiO₂ layer, it was found that the layer had a structure comprising crystalline grains of about 6 nm in diameter separated each other by noncrystalline grain boundaries of about 1 nm, and the crystalline grain arrangement of a hexagonal symmetry was recognized. From a nano-EDX analysis using a probe having about 1 nm diameter, it was found that the primary composition inside the crystalline grains was Co and O, and the primary composition of at the boundary was Si and O. The valence of the cobalt oxide and the silicon oxide were not evaluated, and the film structure was thought to be formed by an eutectic reaction of compounds, or caused by a fractal characteristics of the grain aggregates. Films with similar-structure were found for films formed by simultaneous sputtering of CoO and SiO₂ using binary targets instead of using the composite target.

Etching of the fabricated film was carried out by immersing the film with the substrate in HCl solution. The CoO was chemically etched. Any other etching process including physical process such as reactive ion etching, which removes CoO selectively, can be applied for this etching process. In this stage, the SiO₂ layer had regularly arranged holes with almost equal diameter and at each bottom of the holes, and the Pd under-layer was sure to be appeared.

The substrate was put into the sputtering chamber again and a reverse sputtering was carried out, namely the film side was sputtered in 0.6 Pa Ar gas atmosphere. This process is effective for cleaning up films and atoms formed and attached on the film surface when the film was exposed to the ambient atmosphere. This cleaning process by sputtering was much effective for conductive Pd because a bias voltage was applied to the substrate side. Then clean Pd surfaces at the bottom of the holes of the SiO₂ layer was obtained.

The SiO₂ holes were filled with Ru by sputtering deposition on the substrate using Ru target and applying the bias voltage to the substrate. The bias voltage applied to the substrate seemed not essential in this step because the sputtered Ru is neutral atomic grains, and Ru could deposit in the hole as a result of the bonding energy difference between SiO₂—Ru and Pd—Ru. The bias voltage application to the substrate, however, seemed effective for obtaining selective deposition and surface smoothing due to the mixing and selective sputtering of convex portion by the Ar ions.

2) Analysis of the Granular Film

Cross sectional TEM observation of the granular film layer was carried out for the granular film fabricated by the method described above. As the result, the structure almost the same as the structure already shown FIG. 1 was found. In the granular layer 16, the Ru crystalline grains of the metal grains 14 were grown up in a direction perpendicular to the plane of substrate 12, and each Ru crystalline grain was divided by the amorphous SiO₂ of the inter-grain material 15. The Ru crystalline grains in granular layer 16 was formed exceeding the boundary between the granular layer 16 and the under-layer 13 and penetrating into the under-layer 13. The estimated depth of the Ru crystalline grain 14 penetrating into the under-layer 13 was about 1 to 2 nm. The depth measurement accuracy was limited by the TEM resolution. Furthermore, it was found from lattice image observations of the granular film with high magnification that orientated crystallographical lattice planes were found for both the Pd under-layer and the Ru particles, showing the existence of an epitaxy relationship between the Pd under-layer and the Ru. Since the Ru layer was actually formed also on oxide grain boundary, etching process typically by reverse sputtering carried out after the Ru formation is effective for obtaining a film having further Ru grain separated structure and smoother film.

As a result of X-ray diffraction θ-2θ scan, diffraction peaks near 2θ=40.1° and 42.2° from Pd (111) and Ru (00.2) plane respectively were found was found, and no other peak except for reflections from the substrates. From the rocking curve measurement for Ru (00.2) peak, full half width Δθ₅₀ of 6.3° was obtained, showing that an excellent crystallographic orientation was attained.

### COMPARATIVE EXAMPLE 1

A granular film was fabricated using the same process as described in Example 1 except that the Ru layers were formed without carrying out the reverse sputtering process after etching by HCl solution.

From the cross sectional TEM observation of the film, it was found that one side ends of Ru crystalline grains in the granular layer were at the boundary between the granular layer and the under-layer. The Ru crystalline grains were not exceeded the boundary. As a result of θ-2θ scan using X-ray diffraction, diffraction peaks other than Ru (00.2) plane were observed. From the rocking curve measurement for Ru (00.2) peak, it was found that the full half width Δθ₅₀ was 9.7°, showing that the crystallographic orientation degree was inferior to the orientation degree of the sample fabricated in Example 1.

These results imply that contamination formed on the film surface when the film was exposed to the ambient atmosphere was not removed. In this comparative example, the bonding between Pd and Ru was not sufficient to orient Ru crystallographically, even if is known that the Pd surface does not form oxide.

### COMPARATIVE EXAMPLE 2

A granular-film was fabricated using the same process as described in Example 1, except that the step of forming CoO—SiO₂ layers and treating the layer successively after depositing Pd under-layer was replaced by a step of forming a 10 nm thick Ru—SiO₂ granular layer by sputter deposition process using a Ru—SiO₂ composite target.

From a planar TEM observation of the Ru—SiO₂ granular layer, it was found that the grains in the layer have large grain size distribution although the average grain diameter was about 6 nm. Noncrysalline grain boundaries were formed, but the thickness of the boundaries was not uniform. Furthermore, the crystal grains were located at random and no regularity in grain arrangement was recognized. From cross-sectional TEM observation of the layer, it was found that one side ends of Ru crystalline grains in the granular layer were at the boundary between the granular layer and under-layer and not exceeded the boundary.

It is considered that these results are caused by the fact that the combination of Ru and SiO₂ shows neither eutectic reaction nor fractal character, and even if the Ru layer is formed on a clean surface of Pd under-layer, the depth of Ru grains penetrating and diffusing into the Pd layer from the Pd surface is less than 1 nm.

### EXAMPLE 2

Similar results with Example 1 were obtained replacing the cobalt oxide by iron oxide and by nickel oxide in Example 1. Furthermore, results similar to Example 1 were obtained by replacing silicon oxide respectively by titanium oxide, aluminum oxide, chromium oxide, zirconium oxide, zinc oxide and tantalum oxide in Example 1.

### EXAMPLE 3

1) Fabrication of Perpendicular Magnetic Recording Medium

As nonmagnetic glass substrates, a cleaned up disk shaped glass substrates (manufactured by OHARA Co., outer diameter 2.5 inches) were used. The glass substrates were put into the DC magnetron sputtering apparatus (ANERVA Co. C-3010) chamber, and evacuated the vacuum chamber to 2×10⁻⁵ Pa or less. Each substrate was heated to 200° C., and then magnetron sputtering was carried out as described below in Ar gas atmosphere.

First of all, a 40 nm thick CrMo under-layer was formed to each substrate, and then a 40 nm thick hard magnetic CoCrPt layer was formed on the under-layer as an in-plane hard magnetic layer. A 200 nm thick CoZrNb alloy soft magnetic layer 22 was formed on the hard magnetic layer and then the substrate was once taken out to the ambient atmosphere.

Each substrate cooled down at the ambient atmosphere was put into the sputtering chamber again, and a granular layer similar to the granular layer described in Example 1 was formed on the soft magnetic CoZrNb layer. Then the following sputtering film formation processes were carried out successively in the chamber.

A 15 nm thick CoPtCr—SiO₂ perpendicular magnetic recording layer was formed on the CoZrNb soft magnetic layer by RF sputtering deposition using (Co-16 at % Pt-10 at % Cr)-8 mol % SiO₂, composite target. Then a 5 nm thick carbon protect layer was formed.

Each substrate having the sputter deposited layers was took out from the chamber and a perpendicular magnetic recording medium was obtained by forming a 1.3 nm thick perfluoropolyether lubricant layer on the protect layer by using a dipping method.

The CoCrPt in-plane hard magnetic layer was magnetized toward the radial directions of the disk by applying a radially directed magnetic field of 15 kOe using a specially designed electromagnet magnetizer. A perpendicular magnetic recording disk described below without notice is the magnetized disk described above.

2) Evaluation of the Perpendicular Magnetic Recording Medium

From a cross sectional TEM observation result for the fabricated perpendicular magnetic recording medium it was found that the structure was almost the same as the structure already schematically shown in FIG. 2. The CoZrNb layer corresponding to the soft magnetic layer 22 of the perpendicular magnetic recording medium was uniform and no grain (grain) boundary was recognized in the layer. The structure of the layer could be regarded as amorphous taking the alloy composition of the layer well fitted to form amorphous structure also into account. The Pd layer corresponding to under-layer 13 of the medium was formed on soft magnetic layer 22 instead of nonmagnetic metal under-layer 13 in Example 1. It was found that the Ru crystalline grains 14 were separated each other by amorphous SiO₂ inter-grain material 15 and were grown toward the perpendicular direction as shown in FIG. 2. It was also found that the crystalline Ru grains 14 were grown exceeding their bottoms over the boundary of inter-grain material 15 to under-layer 13 and the bottoms of the Ru grains 14 were penetrated into the under-layer 13. Moreover, an epitaxy relationship between the Pd and the Ru was recognized. In the perpendicular magnetic recording layer, it was also found that crystalline grains 27 separated by inter-grain material 28 were epitaxially grown continuously from the Ru grains and the inter-grain material 28 was grown on the inter-grain material 15.

TEM observation of the perpendicular magnetic recording layer was carried out and in the layer plane, grain diameter distribution characterization was performed according to the following procedure. First of all, an in-plane 0.5×10⁶ to 2×10⁶ magnification TEM photograph having at least 100 or more grain images was arbitrary selected and inputted into a computer as image data and their outlines were picked out using an image data processing. The area occupied by each grain was calculated counting number of pixels in each outlines. Then each grain diameter was calculated assuming each grain outline was circular. The average diameter and the standard deviation of the grains were obtained statistically processing the frequency distribution of the calculated grain diameters assuming a normal distribution. The obtained average diameter of the magnetic grains was 5.3 nm and the standard deviation was 0.8 nm.

Periodicity of the grain arrangement was estimated by processing in plane TEM photograph image data inputted into the computer and carrying out two-dimension fast Fourier transformation. A hexagonal grain arrangement regularity was clearly recognized in real space image before the transformation. The hexagonal symmetrical grain arrangement was confirmed by four clear peaks found in the transformed spectrum image.

As a result of θ-2θ scan using X-ray diffraction, diffraction peaks near 2θ=43.5° by (00.2) plane of CoPtCr—SiO₂ recording layer, and no other clear peak was observed except for diffractions from the substrate. From the rocking curve measurement of the diffraction peak, full half width Δθ₅₀ of 6.6° was obtained. This result showed that excellent crystallographic orientation of the grains was obtained.

The recording and reproducing characteristics of the fabricated perpendicular recording medium was evaluated using a read write analyzer 1632 (Read Write Co., USA) and spin stand S1701 MP. The recording and reproducing head having a single pole head carrying saturation flux density of 2T at the recording portion and a GMR element as the reproducing sensor was used. To evaluate the reproducing signal output and noise of the recording medium, reproducing output amplitude S for linear recording density of 50 kFCI and noise square average value Nm of noise for linear recording density of 400 kFCI were measured. As the result, no spike form noise was observed over the disk surface and excellent S/Nm value of 21.4 was obtained. Furthermore, a signal having linear recording density of 100 kFCI was recorded to the recording medium and the output signal deterioration due to thermal fluctuation was evaluated. The output signal was regularly measured for 100,000 seconds after recording operation was finished. The output signal decrease was within measurement error, so the signal attenuation rate was evaluated as −0 dB/decade.

### COMPARATIVE EXAMPLE 3

(Effect of Crystal Orientation)

Magnetic recording medium samples were fabricated by the process described in Example 3, except that a granular layer similar to the granular layer described in Comparative Example 1 was formed on the CoZrNb soft magnetic layer of each substrate after putting the substrate into the sputtering chamber again.

From cross sectional TEM observation for the fabricated medium, it was found that the bottoms of the Ru grains in the granular film were at the boundary of the under-layer and were not penetrated into the under-layer. Similar feature to the Example 3 for the crystal growth in the perpendicular recording layer was observed.

In-plane TEM observation was carried out, and the grain diameter distribution and the grain arrangement regularity were evaluated by processing the in-plane TEM photograph image data. From the evaluated results, it was found that the magnetic grain diameter, the standard deviation of the diameter and regularity and symmetry of the grain arrangement were similar to the results for Example 3.

As a result of θ-2θ scan using X-ray diffraction, diffraction peaks other than the peaks by (00.2) plane of CoPtCr—SiO₂ recording layer were observed. From the rocking curve measurement the peak by (00.2) plane, full half width Δθ₅₀ of 10.2° was obtained. The result showed that the grain crystallographic orientation degree was lower than the orientation degree for Example 3.

The recording and reproducing characteristics of the fabricated perpendicular recording medium was evaluated using the same condition as Example 3. As the result, S/Nm value of 19.3 was obtained. For thermal fluctuation decrease of the output signal, a linear output decrease against logarithmic time scale was found and the signal attenuation rate was −0.04 dB/decade.

The lower S/Nm value and the inferior thermal fluctuation durability of this comparative example were due to the lower crystallographic orientation dispersion and the lower crystallographic orientation dispersion were thought to be caused by the incomplete Pd—Ru epitaxy relationship.

### COMPARATIVE EXAMPLE 4

(Effect of Grain Arrangement)

Magnetic recording medium samples were fabricated by using the process described in Example 3, except that the granular layer on the CozrNb soft magnetic layer after putting the substrate into the sputtering chamber for each sample was replaced by a granular layer similar to the layer described in Comparative Example 2.

From a cross sectional TEM observation for the fabricated medium, it was found that the bottoms of the Ru grains in the granular film were at the boundary of the under-layer and were not penetrated into the under-layer. Similar feature to the Example 3 for the crystal growth in the perpendicular recording layer was observed.

In-plane grain diameter distribution characterization was carried out using in-plane TEM observation and processing the grain image data. The obtained average diameter was 5.7 nm and the standard deviation was 1.5 nm. Visually the distribution of the magnetic grains 27 of the TEM image was at random and clearly different from the grain arrangement found for Example 3. In the fast Fourier transformed image no clear peak due to periodicity of the grain arrangement was found. The result showed that the grain arrangement regularity is hardly found in the layer.

As a result of θ-2θ scan using X-ray diffraction, no diffraction peak other than the diffraction peaks by (00.2) plane of CoPtCr—SiO₂ recording layer was observed. From the rocking curve measurement of the peak, full half width Δθ₅₀ of 6.2° was obtained. The result showed that the grain crystallographic orientation degree was almost the same level as the grain crystallographic orientation degree for Example 3.

The recording and reproducing characteristics of the fabricated perpendicular magnetic recording medium was evaluated using the same conditions for the Example 3. As the result, S/Nm value of 19.0 was obtained. The decrease of the output signal due to thermal fluctuation was evaluated. The output decrease linear with logarithmic time scale and the signal attenuation rate −0.12 dB/decade was obtained.

The deterioration in S/Nm and thermal fluctuation durability was thought to be due to the irregularity of the grain arrangement. The irregularity was due to the combination of Ru and SiO₂ that shows neither congruent reaction nor fractal behavior.

### EXAMPLE 4

(Intermediate Layer)

Magnetic recording media were fabricated by using the process described in Example 3, except that the Ru metal was replaced by Rh metal and by Re metal having similar crystal structure and lattice constant to the Ru metal. Then the results similar to Example 3 were obtained.

Moreover, magnetic recording media were fabricated by using the process described in Example 3, except that the Pd for the under-layer was replaced by Pt metal and by NiFe metal alloy having face centered cubic structure. Then the results similar to Example 3 were obtained.

### EXAMPLE 5

(Inserting Intermediate Layer)

Deposited substrates were put out and cooled at ambient atmosphere by using the same process as described in Example 3. Each substrate was put back to the ambient atmosphere, and a 20 nm thick CoZrNb layer as an under-layer of the granular film layer was deposited again and 5 nm thick Co—SiO₂ layer were formed as granular layers, and then the substrate was again put out from the chamber to the ambient atmosphere. Here, the additional CoZrNb layer formation was effective for obtaining a clean surface. The additional CoZrNb layer is free from producing additional magnetic spacing between a recording magnetic head and the soft magnetic layer. After removing CoO by etching using the similar method described in Example 1, the substrate was put back into the chamber and reverse sputtered. Then Pd—SiO₂ layer was formed using bias sputtering of Pd target. Successively, a 10 nm thick Ru—SiO₂ intermediate layer was formed using a Ru-5 mol % SiO₂ composite target and a CoPtCr—SiO₂ recording layer and carbon protective layer were formed using the same procedure described in Example 1. Then a perpendicular magnetic recording medium was obtained after forming a lubricant layer by the dipping method.

From the cross sectional TEM observation for the perpendicular magnetic recording medium it was found that the structure was almost the same as the structure already schematically shown in FIG. 2. The Pd grains 14 embedded in amorphous SiO₂ inter-grain material 15 were formed exceeding the boundary and penetrated into the CoZrNb under-layer 13. The composite grains composed of Pd, Ru and magnetic grains 27 were found to form successively epitaxially grown columnar structure. Furthermore, it was found that the grain boundary material of the intermediate layer was formed on the SiO₂ material of the granular layer and the intermediate material of the magnetic layer was formed on the grain boundary material of the intermediate layer.

The grain diameter distribution was evaluated from image processing result for the in-plane TEM observation images at the perpendicular magnetic recording layer of the medium. Almost the same good results similar to Example 3 were obtained for the average diameter, the standard deviation of the grain diameter, regularity of grain arrangement and the arrangement symmetry.

Crystallographic orientation degree evaluated using the X-ray diffraction method was also satisfactory. The recording and reproducing characteristics including S/Nm and signal attenuation rate were almost the same as the results for Example 3 and were satisfactory.

These results were compared with the results carried out for comparison with conditions similar to Comparative Examples 3 and 4. It was found effective for decreasing media noise and increasing thermal fluctuation durability to increase the crystallographic orientation degree by penetrating the crystalline grains into the under-layer and regularize the crystalline grain arrangement by using CoO—SiO₂ combination.

The Pd grain growth was not epitaxial to the under-layer because the CoZrNb under-layer is amorphous similar to the soft magnetic layer below the under-layer. The grain growth on the clean surface, however, seemed effective for improving crystallographic orientation.

### EXAMPLE 6

Perpendicular magnetic recording medium samples were fabricated using the same conditions as described in Example 3 except that a Ru intermediate layer of each sample was replaced by a Rh layer and by a Re layer respectively, and results similar to the results for Example 3 were obtained.

Perpendicular magnetic recording media were fabricated using the same condition as described in Example 3 except that crystalline Nd grains in the granular layer were replaced by Pt metal and by NiFe alloy, and results similar to the result for example 3 were obtained.

Furthermore, perpendicular magnetic recording media were fabricated using the same conditions as described in Example 3 except that the under-layer CoZrNb at the granular layer were replaced by nonmagnetic Pd metal and by nonmagnetic Pt. In this case, results similar to the case for Example 3 were obtained by decreasing the thickness to 3 mm instead of 10 nm for the CoZrNb layer because these under-layers were nonmagnetic and behaved as a magnetic spacing for the magnetic circuit between the magnetic head and the soft magnetic layer.

When the crystalline grains and the under-layer were composed of the same material of Pd, Pt or NiFe, it was very difficult to determine whether the crystalline grains of the granular layer were penetrated into the under-layer or not. Judging from the results for other materials, the crystalline grains could be regarded as penetrated into the under-layer.

### EXAMPLE 7

1) Dividing the Ru Layer (1)

The same process as described in Example 3 was applied up to the step of cooing in an ambient atmosphere. Each substrate was put back into the chamber and formed a 5 nm thick Nd under-layer and a 5 nm thick CoO—SiO₂ layer, and then the substrate was put out again from the chamber to the ambient atmosphere. After carrying out an CoO etching process using the same etching step as described in Example 1, the substrate was put into the chamber again, and a Ru—SiO₂ layer was formed by reverse sputtering and by bias sputtering giving bias voltage to the Ru target. Then sputtering deposition of a 5 nm thick Ru—SiO₂ intermediate layer was carried out using a Ru-5 mol % SiO₂ composite target. On this layer, a CoPtCr—SiO₂ recording layer and carbon protective layer were formed by using the procedure described in Example 3, and then a lubricant layer was formed using a dipping method. Then a perpendicular magnetic recording medium was fabricated.

From cross sectional TEM observation of the fabricated perpendicular recording medium, it was found that the Ru grains imbedded in the amorphous SiO₂ grain boundary material layer were extended and penetrated into the Pd under-layer through the boundary between the granular layer and the under-layer. Furthermore, it was found that the epitaxially grown composite columnar grains composed of the granular layer Ru grain, intermediate layer Ru grain and magnetic grain combination were formed in the layers. Furthermore, the inter-grain material of the intermediate layer was formed above the SiO₂ of the granular layer, and inter-grain material of the perpendicular magnetic recording layer was formed above the inter-grain material of the intermediate layer.

The grain diameter distribution was evaluated from the image processing result of the in-plane TEM observation images at the perpendicular magnetic recording layer of the medium. Satisfactory results almost similar to the results for Example 3 were obtained for the average diameter, the standard deviation of the grain diameter, regularity of grain arrangement and the arrangement symmetry.

Crystallographic orientation degree evaluated using the X-ray diffraction method was also satisfactory, and the recording and reproducing characteristics including S/Nm and signal attenuation rate were good, and were almost the same as the results for Example 3.

Experiments adjusting the conditions similar to Comparative Examples 3 and 4 were carried out. From the results it was made clear that the crystallographic orientation degree increase obtained by extending and penetrating the crystalline grains into the under-layer and the crystalline grain arrangement regularization using the CoO—SiO₂ combination were effective for decreasing media noise and increasing thermal fluctuation durability. When the upper Ru—SiO₂ layer in Example 3 was replaced by the layer formed by using the composite target, the crystallinity deterioration effect caused by the process steps increase was expected. It was found that the deterioration effect, however, was sufficiently compensated by the effects of cleaning and smoothing of the Ru—SiO₂ layer.

2) Dividing the Ru Layer (2)

The same process as described in Example 3 was applied up to the step of cooing the substrate in an ambient atmosphere. Each substrate was put back into the chamber and formed a 5 nm thick Nd layer, a 5 nm thick Ru layer as an under-layer for the granular layer, and a 5 nm thick CoO—SiO₂ layer as the granular layer. Then the substrate was put out again from the chamber to the ambient atmosphere. After carrying out the CoO etching using the same etching step as described in Example 1, the substrate was put into the chamber again, and a Ru—SiO₂ layer was formed after reverse sputtering by bias sputtering giving bias voltage to the Ru target. On this layer, a CoPtCr—SiO₂ recording layer and carbon protective layer were formed by using the procedure described in Example 3, and then a lubricant layer was formed using the dipping method. Then a perpendicular magnetic recording medium was fabricated.

The Ru grains in the granular layer and the Ru under-layer were composed of the same element. So, it was difficult to make clear that the Ru grains in the granular layer were extended and penetrated into the under-layer from a cross sectional TEM observation of the fabricated perpendicular recording medium. It could easily be presumed, however, that the Ru grains in the granular layer were extended to the under-layer from the results of the case for other grains with different materials. Furthermore, it was found that the magnetic grains 27 in the recording layer were epitaxially grown on the Ru grains and had composite columnar grain structure, and the inter-grain material layer was formed on the granular SiO₂ layer.

The grain diameter distribution was evaluated from image processing result for the in-plane TEM observation images at the perpendicular magnetic recording layer of the medium. Almost the same satisfactory results as Example 3 were obtained for the average diameter, the standard deviation of the grain diameter, regularity of grain arrangement and the arrangement symmetry.

Crystallographic orientation degree evaluated using the X-ray diffraction method was also satisfactory and the recording and reproducing characteristics including S/Nm and signal attenuation rate were also satisfactory and were almost the same as the results for Example 3.

These results were compared with the results carried out for comparison with conditions similar to Comparative Examples 3 and 4. From the results it was made clear that the crystallographic orientation degree increase due to the extending and penetrating the crystalline grains into the under-layer and the crystalline grain arrangement regularization due to the CoO—SiO₂ combination were effective for decreasing media noise and increasing thermal fluctuation durability.

When the lower Ru—SiO₂ layer in Example 3 was replaced by the Ru layer having no grain or grain boundaries, at least one additional step was required and the grain diameter distribution and the grain arrangement regularity deterioration effect due to the process steps increase were anticipated. It was found, however, that the deterioration effect was compensated to a certain extent by the increasing effect of the grain crystallinity increase.

3) Additional Result

Perpendicular magnetic recording media were fabricated by the methods of Example 7, except that the Ru metal was replaced by Rh metal and by Re metal having similar crystal structure and lattice constant. Then satisfactory results similar to the Example 7 were obtained.

### EXAMPLE 8

(Effect of Spacing)

Perpendicular magnetic recording media were fabricated by the methods of Example 6, except that magnetic CozrNb alloy layer was replaced by nonmagnetic Pd and by nonmagnetic Pt metal, and the thickness was increased to 5, 10 or 15 nm respectively. It was found that the Pd and Pt layer thickness increase gave no notable effect on the crystallographic orientation and magnetic properties such as coercive force, and the effect on the microstructure of the recording layer was small. Therefore, this recording medium system was suitable for investigating the effect of spacing between the magnetic head and the soft magnetic layer.

The magnetic recording and reproducing properties of the fabricated media were evaluated by the method described in Example 3. Especially, overwrite (OW), an index showing the degree of writing to the recording layer (quantity of previously recorded signal remaining after overwriting), the recording resolution dPW₅₀, an index showing sharpness of magnetic transition layer between bits measurements were carried out in this example. It was found that the OW value degraded from 42.1 dB to 36.5 and 32.7 dB, and the dPW₅₀ value degraded from 7.2 ns to 8.0 and 8.4 ns as the thickness increased from 5 nm to 10 and 15 nm.

These results are expected from the expanding effect of the head-recording fields caused by the increase of nonmagnetic layer thickness, namely the increase of spacing between the magnetic recording head and the soft magnetic layer. When the Pd and Pt thickness was 10 nm or more, the recording and reproducing characteristics were not sufficient compared with the case when the thickness is 5 nm. When the Pd or Pt thickness was 5 nm, the magnetic spacing was about 20 nm. Good recording and reproducing characteristics were obtained when the recording medium had magnetic spacing of 20 nm thick or less.

In this case the Pd or Pt thickness was selected as a parameter for changing the spacing. The effect of the spacing upon the recording and reproducing characteristics can be regarded almost the same as changing any nonmagnetic layer thickness. When the under-layer of the granular layer is nonmagnetic, the spacing is the summation of the granular layer (including the under-layer) thickness and the intermediate layer thickness. When the under-layer of the granular layer is magnetic, the spacing is the summation of the granular layer (without including the under-layer) thickness and the intermediate layer thickness.

Although the prevent invention has been shown and described with respect to best mode embodiments thereof, it should be understood by those skilled in art that the foregoing and various other changes in the form and detail without departing from the spirit and scope of the present invention.

1. A granular film, comprising:
a substrate;
a metal under-layer on the substrate; and
a granular layer on the metal under-layer,
wherein the granular layer comprises metal grains partially penetrating the volume into the metal under-layer and inter-grain material separating the metal grains comprising at least one selected from the group consisting of oxide, nitride and carbide.

2. A perpendicular magnetic recording medium, comprising:
a substrate;
a soft magnetic layer on the substrate;
a metal under-layer on the soft magnetic layer;
a granular layer on the metal under-layer; and
a perpendicular magnetic recording layer on the granular film layer,
wherein the granular layer comprises metal grains partially penetrating the volume into the metal under-layer and inter-grain material separating the metal grains comprising at least one selected from the group consisting of oxide, nitride and carbide.

3. A perpendicular magnetic recording medium according to claim 2,
wherein the perpendicular magnetic recording layer comprises magnetic grains having average grain diameter d of d≦6 nm.

4. A perpendicular magnetic recording medium according to claim 2,
wherein the perpendicular magnetic recording layer comprises granular structure of magnetic grains regularly arranged in the perpendicular magnetic recording layer plane and nonmagnetic inter-grain material separating each of the magnetic grains.

5. A perpendicular magnetic recording medium according to claim 2,
wherein the metal grains of the granular layer have a crystal structure selected from the group consisting of hexagonal closed packed structure and face centered cubic structure, and the nonmagnetic inter-grain material of the granular layer is oxide material which has amorphous structure.

6. A perpendicular magnetic recording medium according to claim 2,
wherein the metal grains of the granular layer contain as a main component at least one selected from the group consisting of Ru, Rh, Re, Pd, Pt and Ni.

7. A perpendicular magnetic recording medium according to claim 2,
wherein the nonmagnetic inter-grain material of the granular layer is oxide material which contains as a main component at least one selected from the group consisting of silicon oxide, titanium oxide, aluminum oxide, zinc oxide and tantalum oxide.

8. A perpendicular magnetic recording medium according to claim 2,
wherein the metal under-layer contains as a main component at least one selected from the group consisting of Pd, Pt, Fe, Co and Ni.

9. A perpendicular magnetic recording medium according to claim 2,
wherein the perpendicular magnetic recording medium further comprises an intermediate layer disposed between the granular layer and the perpendicular magnetic recording layer.

10. A perpendicular magnetic recording medium according to claim 9,
wherein the intermediate layer contains as a main component at least one selected from the group consisting of Ru, Rh and Re.

11. A perpendicular magnetic recording medium according to claim 9,
wherein the metal under-layer of the perpendicular magnetic recording medium is nonmagnetic and the total thickness tₜₙ including the granular film, the metal under-layer and the intermediate layer is tₜₙ≦20.

12. A perpendicular magnetic recording medium according to claim 9,
wherein the metal under-layer is magnetic and the total thickness tₜₘ of the granular film and the intermediate layer is tₜₘ≦20 nm.

13. A perpendicular magnetic recording medium according to claim 2,
wherein the perpendicular magnetic recording layer comprises Co as a main component, and further comprises Pt and O.

14. A perpendicular magnetic recording and reproducing apparatus, comprising:
a perpendicular magnetic recording medium comprising a substrate, a soft magnetic layer on the substrate, a metal under-layer on the soft magnetic layer, a granular layer on the metal under-layer, and a perpendicular magnetic recording layer on the granular film layer, wherein the granular layer comprises metal grains partially penetrating the volume into the metal under-layer and inter-grain material separating the metal grains, the inter-grain material) comprising at least one selected from the group consisting of oxide material, nitride material and carbide material;
a driving mechanism driving the perpendicular magnetic recording medium;
a recording and reproducing head mechanism recording information to the perpendicular magnetic recording medium and reproducing the information from the perpendicular magnetic recording medium;
a head driving mechanism driving the recording and reproducing head; and
a recording and reproducing signal processing system processing recording and reproducing signals.

15. A perpendicular magnetic recording and reproducing apparatus according to claim 14,
wherein the recording and reproducing head mechanism comprises a single pole type recording head.
